(19) United States
(12) Patent Application Publication
(10) Pub. No.: US 2026/0229487 A1
(43) Pub. Date: Aug. 6, 2026

(54) LASER DRYING DEVICE

(71) Applicant: TOYOTA JIDOSHA KABUSHIKI KAISHA, Toyota-shi (JP)

(72) Inventors: Tomofumi HIRUKAWA, Miyoshi-Shi (JP); Masato ONO, Nagoya-Shi (JP); Tadashi TERANISHI, Toyota-Shi (JP); Yusuke OISHI, Toyota-Shi (JP); Yosuke SHIMURA, Nagakute-Shi (JP); Hiroshi KAWASAKI, Toyota-Shi (JP); Katsuhisa TSUZUKI, Toyota-Shi (JP); Takashi IZU, Kashiba-Shi (JP)

(73) Assignee: TOYOTA JIDOSHA KABUSHIKI KAISHA, Toyota-Shi (JP)

(21) Appl. No.: 19/424,781

(22) Filed: Dec. 18, 2025

(30) Foreign Application Priority Data
Feb. 4, 2025 (JP) 2025-016990

(51) Int. Cl. H01M 4/04

(52) U.S. Cl. CPC H01M 4/0471

(57) ABSTRACT

A laser drying device for drying an electrode composite material layer, the laser drying device including a laser light source, a furnace body, and a conveying path, in which the electrode composite material layer is conveyed through the furnace body by the conveying path, the electrode composite material layer is irradiated by laser light from the laser light source, through a laser-transparent protective plate of the furnace body, so as to heat the electrode composite material layer such that the electrode composite material layer is dried, the laser-transparent protective plate is fashioned by disposing a plurality of protective plate pieces in a planar direction, and a boundary line in the planar direction between two protective plate pieces that are adjacent to each other is not parallel to a conveying direction of the electrode composite material layer.

### CROSS-REFERENCE TO RELATED APPLICATION

This application claims priority to Japanese Patent Application No. 2025-016990 filed on Feb. 4, 2025. The disclosure of the above-identified application, including the specification, drawings, and claims, is incorporated by reference herein in its entirety.

### BACKGROUND

### 1. Technical Field

The present disclosure relates to a laser drying device.

### 2. Description of Related Art

Laser drying is known as a drying method for drying an electrode composite material layer by which a current collector layer is coated thereupon. Laser drying is characterized by lower energy consumption and a lower environmental impact than hot air drying. Various proposals have been made to improve drying efficiency and quality of laser drying.

Japanese Unexamined Patent Application Publication No. 2023-169591 (JP 2023-169591 A) discloses an electrode body manufacturing method including a conveying step of conveying an electrode body coated with at least one electrode material by a conveying unit, and a drying step of drying the electrode material while conveying the electrode body by the conveying unit, in which the drying step includes an irradiation step of drying the electrode material by irradiating the electrode material by laser when the electrode body is conveyed to at least one first position in a conveying direction of the conveying unit, and a recovery step of recovering vapor generated as a result of the electrode material being irradiated with the laser by a vapor recovery unit provided to at least one second position adjacent to the first position in the conveying direction. According to JP 2023-169591 A, JP 2023-169591 A discloses that decrease in drying efficiency when drying an electrode material using laser can be suppressed.

Japanese Unexamined Patent Application Publication No. 2007-52934 (JP 2007-52934 A) discloses a method for manufacturing a battery electrode in which an active material is fixed on a current collecting substrate, the method including a first step of providing the active material in powdered form to a predetermined thickness, and a second step of performing laser scanning from the side of the active material in powdered form so as to bond the active material in powdered form together and fix the active material to the current collecting substrate by heat of the laser light irradiation, the first and second steps being repeated until the active material reaches a predetermined thickness on the current collecting substrate. According to JP 2007-52934 A, JP 2007-52934 A discloses that improved packing property of the active material and improved electrical resistance can be realized, while ensuring production efficiency, and also porosity of the active material can be adjusted by adjusting particle size of the powder, and heating conditions, thereby improving permeability of lithium ions.

Japanese Unexamined Patent Application Publication No. 2023-20819 (JP 2023-20819 A) discloses a method for manufacturing an electrode sheet, which includes a preparation step of preparing a coated sheet having a coated portion coated with an electrode material on a first face of a current collecting sheet having a longitudinal direction in a first direction, and a drying step of conveying the coated sheet in the first direction while irradiating the coated portion by laser light from a plurality of laser heads disposed side by side in the first direction, thereby drying the coated portion to obtain an electrode sheet, in which the drying step includes supplying hot air at a temperature of 50° C. or higher and 140° C. or lower and at a wind speed of 5 m/s or higher to laser-irradiated portions of the conveyed coated sheet that have been irradiated by laser light from the laser heads, until the next laser irradiation. According to JP 2023-20819 A, JP 2023-20819 A discloses that an electrode sheet can be manufactured in which decrease in peeling strength between an electrode layer and the current collecting sheet is suppressed, while suppressing increase in drying time.

### SUMMARY

A furnace body is provided with a protective plate that is laser-transparent, and an electrode composite material layer inside the furnace body is irradiated by laser light from a laser light source outside the furnace, through the protective plate, thereby doing away with the need to dispose the laser light source inside the furnace body of which the temperature is high, and also enabling thermal insulation between the laser light source and the furnace body.

Also, in this case, shortening distance between the protective plate and the electrode composite material layer can reduce size of the furnace body, and drying efficiency can be improved. On the other hand, in this case, distance between the protective plate and the laser light source becomes greater, and the area of the protective plate irradiated by the laser light becomes greater, an accordingly a protective plate with a large area needs to be prepared.

However, it is difficult to prepare a large-area singular protective plate made of quartz glass or the like. Conversely, a protective plate can be configured by arraying a plurality of protective plate pieces side by side in a planar direction, but difference in transmittance of laser light of the protective plate pieces themselves, and at boundaries among the protective plate pieces, may lead to uneven drying of the electrode composite material layer in some cases.

Accordingly, an object of the present disclosure is to provide a laser drying device that can suppress uneven drying of an electrode composite material layer even when a large-area protective plate is configured by arraying multiple protective plate pieces side by side in the planar direction.

The present disclosure achieves the above object by the following means.

### Aspect 1

A laser drying device for drying an electrode composite material layer,
the laser drying device including a laser light source, a furnace body, and a conveying path, in which
the electrode composite material layer is conveyed through the furnace body by the conveying path,
the electrode composite material layer is irradiated by laser light from the laser light source, through a laser-transparent protective plate of the furnace body, so as to heat the electrode composite material layer such that the electrode composite material layer is dried,
the laser-transparent protective plate is fashioned by disposing a plurality of protective plate pieces in a planar direction, and
a boundary line in the planar direction between two protective plate pieces that are adjacent to each other is not parallel to a conveying direction of the electrode composite material layer.

### Aspect 2

The laser drying device according to Aspect 1, in which an angle between the boundary line and the conveying direction is 10° or greater and 170° or smaller.

### Aspect 3

The laser drying device according to Aspect 1 or 2, in which the following relation is satisfied

y/x≤0.15
where x is a distance between the laser light source and the electrode composite material layer and y is a distance between the laser-transparent protective plate and the electrode composite material layer.

### Aspect 4

A manufacturing method of an electrode laminate using the laser drying device according to any one of Aspects 1 to 3, the manufacturing method including irradiating the electrode composite material layer with which a current collector layer is coated, by the laser light from the laser light source through the laser-transparent protective plate.

According to the present disclosure, a laser drying device that can suppress uneven drying of an electrode composite material layer, even when a large-area protective plate is formed by arraying a plurality of protective plate pieces side by side in a planar direction, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram for describing a laser drying device according to the present disclosure;

FIG. 2A is a schematic diagram for describing the laser drying device according to the present disclosure;

FIG. 2B is a schematic diagram for describing the laser drying device according to the present disclosure; and

FIG. 3 is a schematic diagram for describing a laser drying device according to the present disclosure.

### DETAILED DESCRIPTION OF EMBODIMENTS

An embodiment of the present disclosure will be described in detail below. Note that the present disclosure is not limited to the following embodiment, and can be carried out in various modifications within the scope of the gist of the present disclosure.

### Laser Drying Device

A laser drying device for drying an electrode composite material layer, the laser drying device including a laser light source, a furnace body, and a conveying path, in which
the electrode composite material layer is conveyed through the furnace body by the conveying path,
the electrode composite material layer is irradiated by laser light from the laser light source, through a laser-transparent protective plate of the furnace body, so as to heat the electrode composite material layer such that the electrode composite material layer is dried,
the laser-transparent protective plate is fashioned by disposing a plurality of protective plate pieces in a planar direction, and
a boundary line in the planar direction between two protective plate pieces that are adjacent to each other is not parallel to a conveying direction of the electrode composite material layer.

According to the present disclosure, a laser drying device that can suppress uneven drying of an electrode composite material layer, even when a large-area protective plate is formed by arraying a plurality of protective plate pieces side by side in a planar direction, can be provided.

Regarding when laser drying an electrode composite material layer while performing conveyance thereof within a furnace body, the present inventors studied disposing a laser-transparent protective plate in the furnace body to insulate a laser light source from inside of the furnace body, such that laser light from the laser light source is irradiated onto the electrode composite material layer through the laser-transparent protective plate, and reducing distance between the laser-transparent protective plate and the electrode composite material layer to improve drying efficiency. When a large-area laser-transparent protective plate, in which multiple protective plate pieces were arrayed side by side, was used to reduce the distance between the laser-transparent protective plate and the electrode composite material layer, transmittance of laser light differed between the protective plate pieces themselves and boundaries among the multiple protective plate pieces, which resulted in variance in intensity of the laser light by which the electrode composite material layer was being irradiated, and consequently in uneven drying of the electrode composite material layer occurring.

In contrast, the present inventors found that uneven drying of the electrode composite material layer can be suppressed by forming and disposing the laser-transparent protective plate such that the boundary lines in the planar direction of two adjacent protective plate pieces are not parallel to the conveying direction of the electrode composite material layer. When there is a boundary line that is parallel to the conveying direction, a portion of the electrode composite material layer situated directly below the boundary line remains situated directly below the boundary line even when conveyed, resulting in a smaller amount of laser irradiation than at other portions of the electrode composite material layer, and consequently in uneven drying occurring. Accordingly, by doing away with boundary lines parallel to the conveying direction, the portion of the electrode composite material layer situated directly below the boundary line is no longer situated directly below the boundary portion once conveyed, whereby uneven drying can be suppressed.

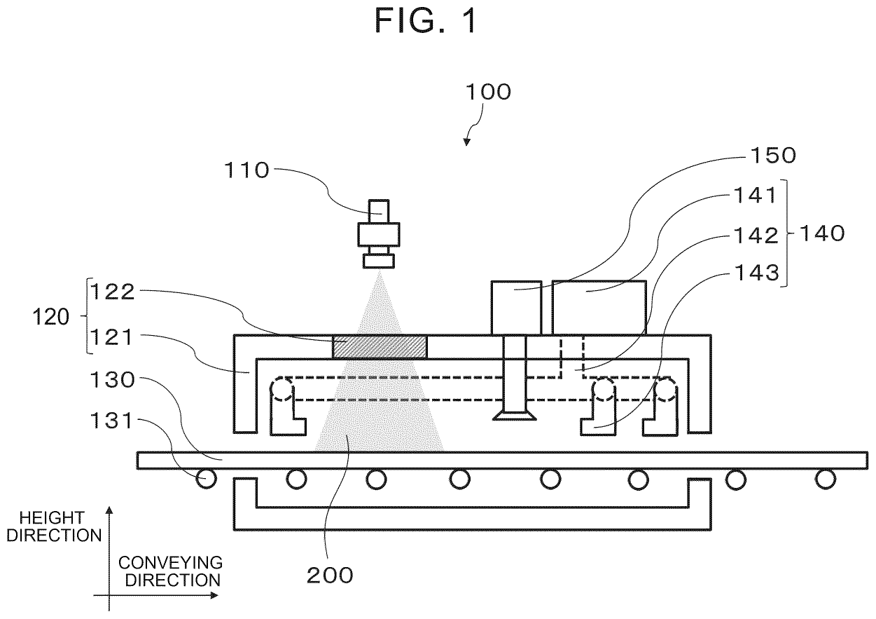

Specifically, as illustrated in FIG. 1 for example, a laser drying device 100 includes a laser light source 110, a furnace body 120, and a conveying path 130. Also, the conveying path 130 can move the electrode composite material layer disposed on the conveying path 130 at a constant speed in the conveying direction, by rotating conveying rollers 131. Therefore, the electrode composite material layer can be carried in from outside of the furnace body 120 into inside of the furnace body 120, and the electrode composite material layer can be carried out from the inside of the furnace body 120 to the outside of the furnace body 120.

The furnace body 120 is made up of an exterior shell 121 and a laser-transparent protective plate 122. The electrode composite material layer that is conveyed into the furnace body 120 via the conveying path 130 is irradiated by laser light 200 from the laser light source 110 disposed outside the furnace body 120, through the laser-transparent protective plate 122, while being conveyed inside the furnace body 120.

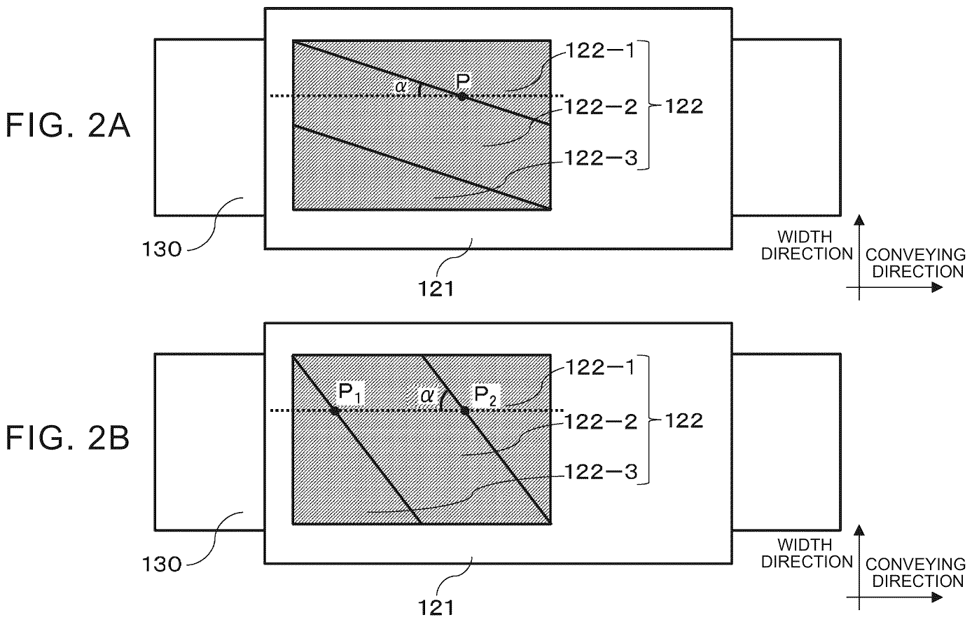

As illustrated in FIGS. 2A and 2B, the laser-transparent protective plate 122 is formed by arraying a plurality of protective plate pieces 122-1 through 3 side by side in the planar direction. Further, a boundary line in the planar direction between the two protective plate pieces 122-1 and 122-2 that are adjacent to each other is not parallel to the conveying direction of the electrode composite material layer, and similarly, a boundary line in the planar direction between the protective plate pieces 122-2 and 122-3 is not parallel to the conveying direction of the electrode composite material layer.

The laser drying device 100 also includes hot air supplying equipment 140, and the hot air supplying equipment 140 is made up of a hot air generator 141, an air supply duct 142, and an air supply nozzle 143. The hot air supplying equipment 140 supplies hot air generated by the hot air generator 141 into the furnace body 120 via the air supply duct 142 and the air supply nozzle 143. Note that the hot air is supplied in the conveying direction and in a direction opposite to the conveying direction. Vapor that is generated near the surface of the electrode composite material layer by laser irradiation is removed by the hot air, and further is discharged to the outside of the furnace body 120 by exhaust equipment 150. Thus, drying efficiency of the electrode composite material layer can be improved.

Note that while the inside of the furnace body 120 becomes hot due to the hot air, the laser light source 110 is protected from the heat inside the furnace body 120 by the laser-transparent protective plate 122 being present between the laser light source 110 and the inside of the furnace body 120, thereby suppressing the heat from being transferred to the laser light source.

The laser drying device according to the present disclosure is a laser drying device for drying the electrode composite material layer.

In the context of the present disclosure, “electrode composite material” means a composition that can make up an electrode active material layer, either as it is, or by further containing other components. Also, “electrode composite material layer” refers to a layer that contains a dispersion medium in addition to “electrode composite material” and that can be applied and be dried to form an electrode active material layer.

The laser drying device according to the present disclosure includes the laser light source, the furnace body, and the conveying path. The laser drying device may further include the hot air supplying equipment and the exhaust equipment.

With the distance between the laser light source and the electrode composite material layer as x, and the distance between the laser-transparent protective plate and the electrode composite material layer as y, y/x≤0.15, 0.14, 0.13, 0.12, 0.10, 0.08, or 0.05, may be satisfied. When the above relation is satisfied, drying efficiency of the electrode composite material layer increases. Also, y/x≥0.01, 0.02, 0.03, or 0.04 may be satisfied.

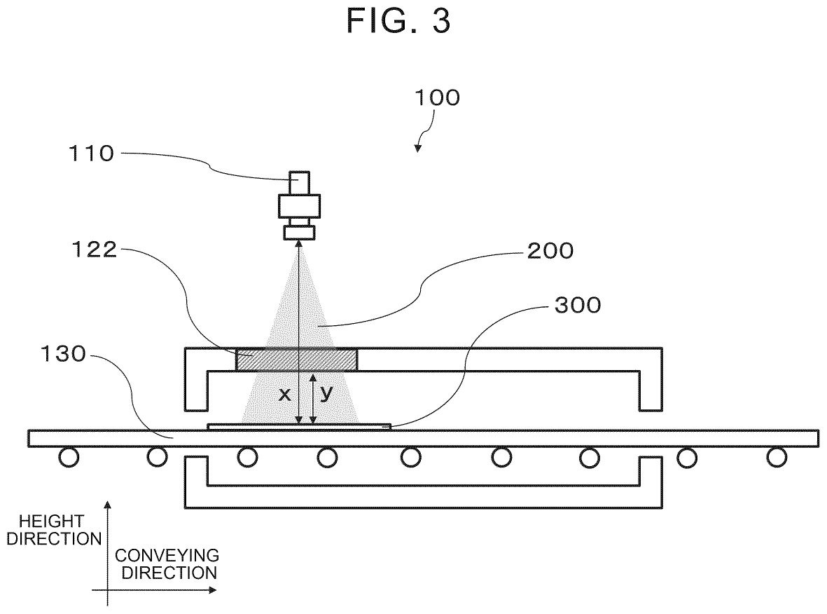

Specifically, as illustrated in FIG. 3 for example, an electrode composite material layer 300 is disposed on the conveying path 130 and is irradiated by the laser light 200. The above x is the shortest distance in a height direction from the laser light emitting portion of the laser light source 110 to the electrode composite material layer 300. Also, the above y is the shortest distance in the height direction from the laser-transparent protective plate 122 to the electrode composite material layer 300.

The distance x between the laser light source and the electrode composite material layer is not limited in particular, and may be determined as appropriate, taking into consideration a region to be irradiated by the laser light, and so forth. The distance x may be, for example, 300 mm or more, 500 mm or more, 1000 mm or more, 1500 mm or more, or 2000 mm or more, and may be 5000 mm or less, 4000 mm or less, or 3000 mm or less.

The distance y between the laser-transparent protective plate and the electrode composite material layer is not limited in particular, and may be determined as appropriate taking into consideration y/x, the thickness of the electrode composite material layer, and so forth. The distance y may be, for example, 5 mm or more, 10 mm or more, 30 mm or more, 50 mm or more, or 100 mm or more, and may be 750 mm or less, 500 mm or less, 400 mm or less, or 300 mm or less.

### Laser Light Source

The laser light source irradiates the electrode composite material layer by laser light, through the laser-transparent protective plate of the furnace body, thereby heating, and consequently drying, the electrode composite material layer.

Energy density of the laser light emitted from the laser light source onto the electrode composite material layer in the furnace body is not limited in particular, and may be, for example, 0.1 W/cm² or more, 0.5 W/cm² or more, 1.0 W/cm² or more, 2.0 W/cm² or more, or 3.0 W/cm² or more, and may be 20.0 W/cm² or less, 10.0 W/cm² or less, 7.0 W/cm² or less, or 4.0 W/cm² or less.

The laser light source may be disposed outside the furnace body. When the temperature inside the furnace body is high, the laser light source can be protected from high heat by disposing the laser light source, which is insulated, outside the furnace body.

The type of laser light source is not limited in particular, and may be, for example, a Yb fiber laser, a YAG laser, a carbon dioxide laser, or the like. The wavelength of the laser light may be 0.5 μm or more, 0.6 μm or more, 0.7 μm or more, 0.8 μm or more, or 0.9 μm or more, and may be 1.5 μm or less, 1.4 μm or less, 1.3 μm or less, 1.2 μm or less, or 1.1 μm or less. The laser light may be of a single wavelength or of a plurality of wavelengths.

The output of the laser light source is not limited in particular, and may be determined as appropriate in accordance with the region to be irradiated by the laser light, the time over which irradiation by the laser light can be performed, and so forth. The output of the laser light source may be, for example, 0.1 kW or more, 1 kW or more, 5 kW or more, 10 kW or more, 15 kW or more, 20 kW or more, or 30 kW or more, and may be 100 kW or less, 70 kW or less, or 50 kW or less.

The number of the laser light sources is not limited in particular, and may be determined as appropriate in accordance with the region to be irradiated by the laser light, the time over which irradiation by the laser light can be performed, and so forth. The number of the laser light sources may be, for example, 1 or more, 2 or more, 3 or more, 5 or more, or 10 or more, and may be 30 or less, or 20 or less.

The shape of the region of the electrode composite material layer that is irradiated by the laser light may be, for example, rectangular. The size of the region to be irradiated is not limited in particular, and may be determined as appropriate in accordance with the dimensions of the electrode composite material layer.

### Furnace Body

The furnace body has the laser-transparent protective plate. As illustrated in FIG. 1, the furnace body has the exterior shell and the laser-transparent protective plate. At least part of the exterior of the furnace body may be the laser-transparent protective plate. The laser-transparent protective plate may be disposed at a position at which the electrode composite material layer can be irradiated in full by the laser light emitted from the laser light source through the laser-transparent protective plate.

The material of the exterior shell is not limited in particular, and may be, for example, steel, stainless steel, aluminum, or the like. The exterior shell may be subjected to surface treatment such as zinc plating, powder coating, or the like. The size of the furnace body is not limited in particular, and may be determined as appropriate taking into consideration the dimensions of the electrode composite material layer and so forth.

The dimensions of the furnace body are not limited in particular, and may be determined as appropriate taking into consideration the dimensions of the electrode composite material layer and so forth. The furnace body may also have an opening for carrying in and carrying out the electrode composite material layer using conveying equipment.

From the perspective of increasing drying efficiency of the electrode composite material layer, the furnace body preferably has high heat insulation properties, and may have a thermal insulating material on an outer side of the exterior shell. Examples of thermal insulating materials include fire brick, ceramic fiber, glass wool, and so forth.

### Laser-Transparent Protective Plate

The laser-transparent protective plate is fashioned by disposing multiple protective plate pieces in the planar direction. In the context of the present disclosure, the “planar direction” of protective plate pieces means a direction parallel to the principal faces (largest face) of the protective plates. Specifically, this may be any direction perpendicular to the height direction in FIG. 1, for example.

The boundary line in the planar direction between two protective plate pieces that are adjacent to each other is not parallel to the conveying direction of the electrode composite material layer. When the laser-transparent protective plate has a plurality of the boundary lines, the boundary lines may be parallel to each other, but do not have to be parallel to each other.

An angle between the boundary line and the conveying direction may be 100 or greater and 1700 or smaller. Specifically, the angle is the angle α in FIGS. 2A and 2B, for example. The angle may be 150 or greater, 200 or greater, 25° or greater, 300 or greater, 350 or greater, 400 or greater, 450 or greater, or 500 or greater, and may be 1650 or smaller, 1600 or smaller, 1550 or smaller, 1500 or smaller, 1450 or smaller, 1400 or smaller, 1350 or smaller, or 1300 or smaller.

As illustrated in FIG. 2A, when viewed from the height direction, there may be one intersection point P between any one line parallel to the conveying direction and the boundary line. Due to the presence of the intersection point P, the boundary line is not parallel to the convey direction, and uneven drying can be suppressed. Also, as illustrated in FIG. 2B, there may be two or more intersection points P (P₁, P₂). Making the number of the intersection points of each line that is parallel to the conveying direction to be the same enables further suppressing of uneven drying. In addition, the number of the intersection points is preferably small. Due to the number of the intersection points being small, each portion of the electrode composite material layer passes directly under boundary lines less frequently, and the amount of energy of the laser light by which irradiation is performed increases, thereby improving drying efficiency.

The number of protective plate pieces is not limited in particular, and may be determined as appropriate taking into consideration the positional relation of the boundary portions of the protective plate, the dimensions of the protective plate pieces, and the area of the laser-transparent protective plate that is irradiated by laser light.

Two protective plate pieces adjacent to each other in the planar direction may be bonded together by an adhesive. The adhesive is preferably an adhesive that is applicable to optical equipment, has high laser light transmittance, and also is highly heat resistant. The adhesive may be, for example, an ultraviolet curing adhesive, an epoxy-based adhesive, or the like.

The laser light transmittance of the protective plate pieces may be 95.0% or more, 96.0% or more, 97.0% or more, 98.0% or more, 99.0% or more, 99.5% or more, or 99.8% or more, or may be 100.0% or less or 99.9% or less, with respect to the laser light emitted from the laser light source. The high transmittance of the laser light allows the light energy generated from the laser light source to be supplied to the electrode composite material layer without waste.

When the laser light is of a single wavelength, the transmittance of laser light is the transmittance at that wavelength, and when the laser light is of a plurality of wavelengths, the transmittance thereof is the transmittance at the wavelength with the highest intensity. The transmittance of the laser light can be measured by spectrophotometry using an ultraviolet-visible-near-infrared spectrophotometer (SolidSpec-3700DUV, manufactured by Shimadzu Corporation).

The material of the protective plate may be glass. The glass may be, for example, quartz glass, soda lime glass, lead glass, borosilicate glass, alkali glass, or the like.

The protective plate pieces may be double-glazed glass. Double-glazed glass improves thermal insulation performance. The double-glazed glass may be one in which air, argon gas, krypton gas, or the like, is sealed between a plurality of panes of glass.

The thickness of the protective plate pieces is not limited in particular, and may be determined as appropriate in accordance with the material of the laser-transparent protective plate pieces, and so forth. The thickness of the laser-transparent protective plate pieces may be, for example, 1 mm or more, 3 mm or more, 5 mm or more, 7 mm or more, or 10 mm or more, and may be 30 mm or less, 25 mm or less, 20 mm or less, or 15 mm or less.

The dimensions of the protective plate pieces are not particularly limited, and may be such that when multiple transmission plate pieces are combined, the laser light generated from the laser light source can pass through in full into the furnace body.

The thermal conductivity of the protective plate pieces is not limited in particular, and may be 1.50 W/(M·K) or less, 1.40 W/(M·K) or less, 1.38 W/(M·K) or less, 1.35 W/(M·K) or less, 1.30 W/(M·K) or less, 1.20 W/(M·K) or less, 1.10 W/(M·K) or less, or 1.00 W/(M·K) or less, or may be 0.10 W/(M·K) or more, 0.30 W/(M·K) or more, or 0.50 W/(M·K) or more. Due to the low thermal conductivity, the laser light source is less susceptible to the temperature inside the furnace body.

Thermal conductivity can be measured by the heat flow meter method in accordance with ASTM E-1530.

### Conveying Equipment

The electrode composite material layer is conveyed through the furnace body by the conveying path. The conveying equipment is not limited in particular, and may be, for example, a roller conveyor, a conveyor belt, or the like.

The electrode composite material layer is irradiated by the laser light while being conveyed over the conveying path inside the furnace body. The conveying speed may be determined as appropriate, taking into consideration the output of the laser light source, the amount of energy necessary to dry the electrode composite material layer, and so forth. The conveying speed may be, for example, 0.1 m/s or more, 0.3 m/s or more, 0.5 m/s or more, or 1.0 m/s or more, and may be 3.0 m/s or less, 2.5 m/s or less, or 2.0 m/s or less.

The conveying path may be connected to other devices, such as a coating device for the electrode composite material layer, and a take-up device for an electrode laminate, or the like.

### Hot Air Supplying Equipment

The hot air supplying equipment supplies hot air into the furnace body. Supplying hot air to the electrode composite material layer enables vapor on the surface of the electrode composite material layer to be removed, and drying efficiency can be improved.

The temperature of the hot air supplied from the hot air supplying equipment may be 50° C. or higher, 100° C. or higher, 130° C. or higher, 150° C. or higher, 160° C. or higher, 180° C. or higher, 200° C. or higher, 220° C. or higher, 240° C. or higher, 260° C. or higher, 280° C. or higher, or 300° C. or higher, and may be 500° C. or lower, 450° C. or lower, 400° C. or lower, or 350° C. or lower.

The hot air supplying equipment is not limited in particular, and may be, for example, one that supplies air heated by gas combustion, oil combustion, electric heating, or the like, to the electrode composite material layer via a blower duct and a blower nozzle using a blower fan. The hot air preferably has low humidity, from the perspective of drying the electrode composite material layer.

A supply direction of the hot air is not limited in particular, and may be a direction opposite to the conveying direction when the electrode composite material layer is conveyed inside the furnace body, for example. Also, a plurality of the blower nozzle may be disposed, and each of these may be disposed such that the supply direction is different one from another.

Wind speed of the hot air is not limited in particular, and may be, for example, 5 m/s or more, 10 m/s or more, 15 m/s or more, or 20 m/s or more. When the wind speed is high, the efficiency of drying the electrode composite material layer is raised. Also, the wind speed of the hot air may be 60 m/s or less, 50 m/s or less, 40 m/s or less, or 30 m/s or less.

### Exhaust Equipment

The laser drying device may have exhaust equipment. Having the exhaust equipment enables vapor generated from the electrode composite material layer to be recovered, thereby improving the drying efficiency. Note that the vapor may be water vapor or other gases.

The exhaust equipment may be configured to draw vapor off through an exhaust port using an exhaust fan, for example, and discharge the vapor to the outside of the furnace body via an exhaust duct. The output of the exhaust fan and the dimensions of the exhaust port and the exhaust duct may be determined as appropriate, taking into consideration the amount of vapor generated, the internal pressure of the furnace body, and so forth.

From a perspective of improving drying efficiency, the exhaust port is preferably disposed above the electrode composite material layer, and also at a position not interfering with the irradiation by laser. The distance between the exhaust port and the electrode composite material layer may be such that the vapor can be drawn off. The number of exhaust ports is not limited in particular.

### Method for Manufacturing Electrode Laminate

A manufacturing method of an electrode laminate using the laser drying device according to the present disclosure, the manufacturing method including irradiating the electrode composite material layer with which a current collector layer is coated, by the laser light from the laser light source through the laser-transparent protective plate.

According to the present disclosure, a manufacturing method of an electrode laminate that can suppress uneven drying of an electrode composite material layer, even when a large-area protective plate is formed by arraying multiple protective plate pieces side by side in the planar direction, can be provided.

The method of the present disclosure is a manufacturing method of an electrode laminate using the laser drying device of the present disclosure. The above description of the laser drying device can be referred to regarding the laser drying device.

The method according to the present disclosure includes irradiating an electrode composite material layer with which a current collector layer is coated, by laser light from a laser light source through a laser-transparent protective plate. The above description of the laser drying device can be referred to regarding the laser light source, the laser-transparent protective plate, the electrode composite material layer, and the laser light. By irradiating the electrode composite material layer with laser light, the dispersion medium contained in the electrode composite material layer is volatilized, and an electrode active material layer is formed.

The dispersion medium contained in the electrode composite material layer is not limited in particular, and may be, for example, a non-polar solvent such as heptane, xylene, toluene, or the like, or a polar solvent such as water, a tertiary amine-based solvent, an ether-based solvent, a thiol-based solvent, a ketone-based solvent (e.g., diisobutyl ketone), an ester-based solvent (e.g., butyl butyrate), or the like.

The content of the dispersion medium is not limited in particular, and may be, for example, an amount such that the solid fraction of the electrode composite material layer is 30% or more, 35% or more, 40% or more, 45% or more, or 50% or more, or may be an amount such that the solid fraction of the electrode composite material layer is 80% or less, 75% or less, 70% or less, 65% or less, or 60% or less.

The method for applying the electrode composite material layer is not limited in particular, and may be the doctor blade method, die coating method, gravure coating method, spray coating method, electrostatic coating method, bar-coating method, or the like.

The time of irradiation by the laser light is not limited in particular, and for example, irradiation may be continued until the decreasing drying rate period of the electrode composite material layer is reached. The time of irradiation by the laser light may be, for example, 30 seconds or more, 1 minute or more, or 2 minutes or more, or may be 30 minutes or less, 20 minutes or less, or 10 minutes or less.

### Electrode Laminate

The electrode laminate may have an electrode active material layer and a current collector layer. The electrode active material layer may be a cathode active material layer or an anode active material layer. The electrode laminate may also be a bipolar electrode laminate having both of the cathode active material layer and the anode active material layer.

### Electrode Active Material Layer

When the electrode active material layer according to the present disclosure is a cathode active material layer, this cathode active material layer contains at least a cathode active material. Also, when the electrode active material layer is an anode active material layer, the anode active material layer contains at least an anode active material. The electrode active material layer may further optionally contain a binder, a solid electrolyte, a conductive aid, and so forth. The electrode active material layer may also contain various other additives. Contents of each of the cathode active material, the anode active material, the binder, the solid electrolyte, the conductive aid, and so forth, in the electrode active material layer may be determined as appropriate, in accordance with intended battery performance.

The material for the cathode active material is not limited in particular as long as it is capable of intercalating and deintercalating lithium ions. Examples of the cathode active material include, but are not limited to, lithium cobalt oxide (LiCoO₂), lithium nickel oxide (LiNiO₂), lithium manganese oxide (LiMn₂O₄), lithium iron phosphate (LFP), lithium manganese iron phosphate (LMFP), nickel-cobalt-manganese lithium oxide (NCM: LiCO_{1/3}Ni_{1/3}Mn_{1/3}O₂), nickel-cobalt-aluminum lithium oxide (LiNi_{0.8}(CoAl)_{0.2}O₂), a heteroelement-substituted Li—Mn spinel having a composition represented by Li₁₊ₓMn_{2-x-y}M_{y}O₄ (where M is one type or more of metal elements selected from Al, Mg, Co, Fe, Ni, and Zn), and the like.

The shape of the cathode active material is not particularly limited as long as it is a general shape for a cathode active material of a battery. The cathode active material may be, for example, in the form of particles. The cathode active material may be primary particles, or may be secondary particles formed by aggregation of a plurality of the primary particles. An average particle size D₅₀ of the cathode active material may be, for example, 1 nm or more, 5 nm or more, or 10 nm or more, and may be 500 μm or less, 100 μm or less, 50 μm or less, or 30 μm or less. Note that the average particle size D₅₀ is the particle diameter (median diameter) corresponding to 50% of a volume-based cumulative particle size distribution value as found by a laser diffraction and scattering method.

As for the anode active material, various substances can be employed that have a potential (charge/discharge potential) of intercalating and deintercalating lithium ions that is lower than that of the cathode active material according to the present disclosure. The material for the anode active material is not limited in particular, and may be metallic lithium, or may be a material that is capable of intercalating and deintercalating metal ions such as lithium ions or the like. Examples of materials capable of intercalating and deintercalating metal ions such as lithium ions or the like include, but are not limited to, alloy-based anode active materials, carbon materials, lithium titanate (Li₄Ti₅O₁₂), and so forth.

The alloy-based anode active material is not limited in particular, and examples thereof include a Si alloy-based anode active material, a Sn alloy-based anode active material, and so forth. The Si alloy-based anode active material includes silicon, silicon oxide, silicon carbide, silicon nitride, solid solutions thereof, and so forth. The Si alloy-based anode active material can also contain metal elements other than silicon, such as, for example, Fe, Co, Sb, Bi, Pb, Ni, Cu, Zn, Ge, In, Sn, Ti, and so forth. The Sn alloy-based anode active material includes tin, tin oxide, tin nitride, solid solutions thereof, and so forth. The Sn alloy-based anode active material can also contain metal elements other than tin, such as, for example, Fe, Co, Sb, Bi, Pb, Ni, Cu, Zn, Ge, In, Ti, Si, and so forth.

The carbon material is not limited in particular, and examples thereof include hard carbon, soft carbon, graphite, and the like.

The shape of the anode active material is not limited in particular, and may be any shape that is common for anode active materials in batteries. The anode active material may be, for example, in the form of particles or a sheet.

The material of the binder is not limited in particular. The binder may be, but is not limited to, materials such as, for example, polyvinylidene fluoride (PVdF), butadiene rubber (BR), polytetrafluoroethylene (PTFE), styrene butadiene rubber (SBR), and the like. The binder is not limited in particular, and one type may be used alone, or two or more types may be used in combination.

The material of the solid electrolyte is not limited in particular, and may be, for example, a sulfide solid electrolyte, an oxide solid electrolyte, a polymer electrolyte, or the like.

Examples of the sulfide solid electrolytes include, but are not limited to, sulfide-based amorphous solid electrolytes, sulfide-based crystalline solid electrolytes, argyrodite-type solid electrolytes, or the like. Specific examples of the sulfide solid electrolytes include Li₂S—P₂S₅-based (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (LiI₃GeP₃Si₆, Li₁₀GeP₂Si₂, etc.), LiI—Li₂S—P₂O₅, LiI—Li₃PO₄—P₂S₅, Li₇₋ₓPS₆₋ₓClₓ, and so forth, or combinations thereof, but are not limited thereto.

Examples of the oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ (LiPON), and so forth, or combinations thereof.

The sulfide solid electrolyte and the oxide solid electrolyte may be glass or crystallized glass (glass-ceramics).

Examples of the polymer electrolytes include, but are not limited to, polyethylene oxide (PEO), polypropylene oxide (PPO), copolymers thereof, and so forth.

The conductive aid is not limited in particular. The conductive aid may be, for example, vapor grown carbon fibers (VGCF), acetylene black (AB), Ketjen black (KB), carbon nanotubes (CNT), carbon nanofibers (CNF), or the like, but is not limited thereto. The conductive aid may be in the form of particles or fibers, for example, and the size thereof is not limited in particular. The conductive aid is not limited in particular, and one type may be used alone, or two or more types may be used in combination.

### Current Collector Layer

The material of the current collector layer is not limited in particular, and any material commonly used as a conductor for a battery electrode can be employed as appropriate. Examples of materials for the conductive layer include, but are not limited to, Cu, Ni, Cr, Au, Pt, Ag, Al, Fe, Ti, Zn, Co, stainless steel, and so forth. Also, the current collector layer may be a metal foil or a substrate on which the above metals are plated or vapor-deposited.

The form of the current collector layer is not limited in particular, and examples thereof include foil, plate, mesh, and so forth. Of these, the foil form is preferred.

The thickness of the current collector layer is not limited in particular, and may be 0.1 μm or more, or 1 μm or more, and may be 1 mm or less, or 100 μm or less.

### Drying Efficiency Evaluation

### Laser Drying Device

Laser drying devices were prepared as Reference Examples 1 to 5 and Reference Comparative Example 1, each having the same configuration as illustrated in FIG. 1 except that the laser-transparent protective plate was a single-plate protective plate, and the distance y between the protective plate and the electrode composite material layer was adjusted as shown in Table 1. Note that the distance x between the laser light source and the electrode composite material layer was 1500 mm. Also, the material of the protective plate was quartz glass, and the transmittance of the laser light emitted from a laser light source with an output of 20 kW was 99.8% at a wavelength of 970 nm. The transmittance of the laser light was measured by spectrophotometry using an ultraviolet-visible-near-infrared spectrophotometer (SolidSpec-3700DUV, manufactured by Shimadzu Corporation). The temperature of the hot air supplied from the hot air supplying equipment was 120° C.

### Measurement of Drying Time

The electrode composite material layer (solid fraction: 55%, basis weight: 35 mg/cm²) was dried using the laser drying devices of Reference Examples 1 to 5 and Reference Comparative Example 1, and the drying time was measured. The results are shown in Table 1. Note that the temperature at the center portion of the electrode composite material layer was continuously measured with a radiation thermometer, and the timing at which the center portion of the electrode composite material layer entered the decreasing drying rate period was defined as the drying time.

TABLE 1

| | Position of | Position of | | |
|---|---|---|---|---|
| | Laser Light | Laser-transparent | | Drying |
| | Source | Protective Plate | | Time |
| | x | y | x/y | (s) |
| Reference | 1500 | 300 | 0.20 | 106 |
| Comparative | | | | |
| Example 1 | | | | |
| Reference | 1500 | 200 | 0.13 | 85 |
| Example 1 | | | | |
| Reference | 1500 | 150 | 0.10 | 80 |
| Example 2 | | | | |
| Reference | 1500 | 100 | 0.07 | 74 |
| Example 3 | | | | |
| Reference | 1500 | 50 | 0.03 | 65 |
| Example 4 | | | | |
| Reference | 1500 | 10 | 0.01 | 50 |
| Example 5 | | | | |

From Reference Examples 1 to 5 and Reference Comparative Example 1, it can be seen that the drying time is shortened by reducing x/y. Accordingly, the drying efficiency can be improved by using a large-area laser-transparent protective plate and reducing x/y.

What is claimed is:

1. A laser drying device for drying an electrode composite material layer,
the laser drying device comprising: a laser light source; a furnace body; and a conveying path, wherein
the electrode composite material layer is conveyed through the furnace body by the conveying path,
the electrode composite material layer is irradiated by laser light from the laser light source, through a laser-transparent protective plate of the furnace body, so as to heat the electrode composite material layer such that the electrode composite material layer is dried,
the laser-transparent protective plate is fashioned by disposing a plurality of protective plate pieces in a planar direction, and
a boundary line in the planar direction between two protective plate pieces that are adjacent to each other is not parallel to a conveying direction of the electrode composite material layer.

2. The laser drying device according to claim 1, wherein an angle between the boundary line and the conveying direction is 10° or greater and 170° or smaller.

3. The laser drying device according to claim 1, wherein the following relation is satisfied
y/x≤0.15
where x is a distance between the laser light source and the electrode composite material layer and y is a distance between the laser-transparent protective plate and the electrode composite material layer.

4. A manufacturing method of an electrode laminate using the laser drying device according to claim 1, the manufacturing method comprising irradiating the electrode composite material layer with which a current collector layer is coated, by the laser light from the laser light source through the laser-transparent protective plate.
